(19) United States
(12) Patent Application Publication
(10) Pub. No.: US 2025/0252172 A1
(43) Pub. Date: Aug. 7, 2025

(54) METHOD AND SYSTEM FOR PERFORMING USER AUTHENTICATION USING GRID PASSWORD

(71) Applicant: Boardwalktech, Inc., Cupertino, CA (US)

(72) Inventors: Ganesh Krishnan, Cupertino, CA (US); Melanie Anne Frederick, Sunnyvale, CA (US); Amitabh Jain, Pleasanton, CA (US); Ronald Nathan, San Jose, CA (US); Dharmesh Dadbhawala, San Jose, CA (US)

(21) Appl. No.: 19/042,957

(22) Filed: Jan. 31, 2025

Related U.S. Application Data
(60) Provisional application No. 63/627,985, filed on Feb. 1, 2024.

(51) Int. Cl. G06F 21/36; G06F 21/60

(52) U.S. Cl. CPC G06F 21/36; G06F 21/602

(57) ABSTRACT

A system and a method may be provided for performing user authentication. The system comprises a processor and a memory coupled to the processor. The memory has stored therein instructions executable by the processor to configure the system to generate a multi-dimensional grid password for a user account, transmit the multi-dimensional grid password to a client device associated with the user account, and iteratively generate a policy for each of a plurality of user authentication sessions. The multi-dimensional grid password comprises a set of cells having corresponding one or more identifiers. The policy for each of the plurality of user authentication sessions comprises a unique set of identifiers from the one or more identifiers of each of the set of cells, and a policy for a session from the plurality of user authentication sessions causes to generate a subset of the multi-dimensional grid password for user authentication during the session.

### CROSS-REFERENCE TO RELATED APPLICATION

This application claims the benefit of priority to U.S. Provisional Patent Application No. 63/627,985 entitled “Method and System For Performing User Authentication Using Grid Password” filed on Feb. 1, 2024 which is incorporated herein by reference.

### TECHNOLOGICAL FIELD

The present disclosure generally relates to user authentication for security, and more particularly, relates to authentication of users for account access using grid passwords.

### BACKGROUND

As computing technology has advanced and use of the Internet has become widespread, online platforms are being used in a variety of different manners. For example, users may access services, such as transaction services, communication services, data processing services, schedule organization services, etc. associated with online platforms via the Internet. To this end, the online platforms may oftentimes require to have the users authenticated so that the services are provided to the user in a secure manner. Moreover, the online platform needs to authenticate users to know that a user accessing a service on the online platform is in fact a person that they claim to be. Providing such authentication, however, remains a difficult problem due to increasing incidents of cyber-attacks, such as by URL sniffing, password guessing, etc.

### BRIEF SUMMARY

The present invention discloses a system and a method for user authentication of a user account by using a multi-dimensional grid password.

In one aspect, the present disclosure discloses a system for performing user authentication. The system comprises a processor and a memory coupled to the processor. The memory has stored therein instructions executable by the processor to configure the system to generate a multi-dimensional grid password for a user account, transmit the multi-dimensional grid password to a client device associated with the user account, and iteratively generate a policy for each of a plurality of user authentication sessions. The multi-dimensional grid password comprises a set of cells having corresponding one or more identifiers. The policy for each of the plurality of user authentication sessions comprises a unique set of identifiers from the one or more identifiers of each of the set of cells, and a policy for a session from the plurality of user authentication sessions causes to generate a subset of the multi-dimensional grid password for user authentication during the session.

In accordance with addition system embodiments, the processor is further configured to generate a first policy for a first user authentication session during a previous user authentication session, store a copy of the first policy, and transmit the first policy to the client during the previous user authentication session, wherein the previous user authentication session occurs during a time period prior to a time period associated with the first user authentication session.

In accordance with addition system embodiments, the processor is further configured to cause the client to generate a first subset of the multi-dimensional grid password based on the first policy for user authentication during the first user authentication session.

In accordance with addition system embodiments, the processor is further configured to receive the first subset from the client of the multi-dimensional grid password from the client, determine a comparison subset for the user authentication using the stored first policy and the multi-dimensional grid password, compare the received first subset with the comparison subset, and authenticate the user for the first user authentication session based on the comparison.

In accordance with addition system embodiments, the first subset of the multi-dimensional grid password is encrypted using the first policy, and wherein the first policy is known to the client and the system.

In accordance with addition system embodiments, the first subset of the multi-dimensional grid password comprises a first set of values corresponding to one or more cells from the set of cells.

In accordance with addition system embodiments, the processor is further configured to generate a set of data packets corresponding to the multi-dimensional grid password, wherein each data packet of the set of data packets corresponds to a cell from the set of cells of the multi-dimensional grid password; and transmit each data packet of the set of data packets consecutively to the client.

In another aspect, the present disclosure discloses a method for performing user authentication. The method comprises generating a multi-dimensional grid password for a user account, the multi-dimensional grid password comprising a set of cells having corresponding one or more identifiers; transmitting the multi-dimensional grid password to a client device associated with the user account; and iteratively generating a policy for each of a plurality of user authentication sessions. The policy for a session from the plurality of user authentication sessions comprises a unique set of identifiers from the one or more identifiers of the set of cells, the unique set of identifiers corresponding to a subset of cells, and the policy for the session causes to generate a subset of the multi-dimensional grid password for user authentication during the session.

### BRIEF DESCRIPTION OF DRAWINGS

Having thus described example embodiments of the disclosure in general terms, reference will now be made to the accompanying drawings, which are not necessarily drawn to scale, and wherein:

FIG. 1 illustrates a schematic diagram of a network environment within which a system for performing user authentication is implemented, according to an embodiment of the present disclosure;

FIG. 2 illustrates a block diagram of the system for performing user authentication, according to an embodiment of the present disclosure;

FIG. 3A shows a sequence diagram that depicts a method for setting up a user account for a user with the multi-dimensional grid password, according to an embodiment of the present disclosure;

FIG. 3B shows a sequence diagram that depicts a method for performing a user authentication session, according to an embodiment of the present disclosure; and

FIG. 4 illustrates a flowchart for implementation of an exemplary method for performing user authentication, according to an embodiment of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced item. Moreover, various features are described which may be exhibited by some embodiments and not by others. Similarly, various requirements are described which may be requirements for some embodiments but not for other embodiments.

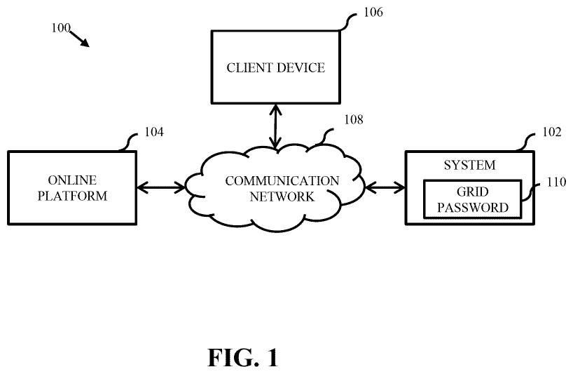

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect. Turning now to FIG. 1-FIG. 4, a brief description concerning the various components of the present disclosure will now be briefly discussed. Reference will be made to the figures, showing various embodiments of a system for performing user authentication.

FIG. 1 shows a schematic diagram of a network environment 100 within which a system 102 for performing user authentication is implemented, according to one embodiment of the present disclosure. The environment comprises an online platform 104 that may provide certain services. Further, a user may access the services provided by the online platform 104 using a client device 106. For example, the online platform 104 may be associated with an e-commerce, a social media platform, an education platform, a business or corporate website, an entertainment website, and so forth.

Typically, the user may create a user account on the online platform 104 to access the services of the online platform 104. For providing the services to the user, the online platform 104 may be required to authenticate the user to ensure that only authorized users can gain access to the services provided by the online platform 104. To this end, the user may have to provide authentication information, such as a password, a pin, a code, etc. to enable their authentication. In recent years, password attacks, such as URL sniffing, password guessing, brute force attack, key loggers attack, man-in-the-middle attack, etc. has increased manifolds.

The present disclosure aims to overcome problems associated with password remembrance by user and password attacks, such as password guessing and reconstruction of password by continued URL sniffing. Typically, the user may have to remember their password in order to access their user account. However, this may be inconvenient for the user. In certain cases, the user may forget the password causing them to lose access of their user account or recovering account after a great number of trials and problems. This may cause data loss and may hamper user experience adversely.

For example, if a password of the user for the user account is simple, then adversaries with no prior knowledge of legitimate credentials of the user may guess user id and/or passwords of the user account to attempt access to the user account.

Further, in certain cases, the user may save their password on their browser for easy access to the user account. The password may be repeatedly transmitted to the online platform 104 for authentication of the user. However, such repeated transmission of the password may render the password prone to security threats. For example, the password may be intercepted by fraudulent parties, such as a man-in-the-middle or a URL sniffer while being communicated over a communication network 108 to the online platform 104. To this end, such storing of password on the browser and repeated transmission of the password may fail to ensure security of the user account.

The present disclosure discloses the system and the method for performing user authentication of the user account by using a multi-dimensional grid password 110. In particular, the system 102 is configured to create the grid password 110 for the user account associated with the user and/or a user id of the user. The grid password 110 may enable secure authentication of the user to provide access to the user account and the services provided by the online platform 104. The grid password 110 is a multi-dimensional password.

In an example, the system 102 may be configured to create the grid password 110 when the user signs-up on the online platform 104 to create the user account, such as using the client device 106. For example, a copy of the grid password 110 for the user account may be sent to the user or the client device 106. The client device 106 may store the copy of the grid password 110 for user authentication.

Additional, fewer, or different components may be provided in the network environment 100. For example, a server, a router, a switch or intelligent switch, a database, additional computers or workstations, administrative components, such as an administrative workstation, a gateway device, a backbone, ports, network connections, and network interfaces may be provided. While the components in FIG. 1 are shown as separate from one another, one or more of these components may be combined. In this regard, a processor of the system 102 for performing the user authentication may be communicatively coupled to the components shown in FIG. 1 to carry out the desired operations and wherever required modifications may be possible within the scope of the present disclosure.

In an example embodiment, the system 102 for performing the user authentication may be implemented within the online platform 104, such as the system 102 may be a user authentication module in the online platform 104 for authenticating users and enabling access to services of the online platform 104.

The system 102 may be communicatively coupled to the online platform 104, the client device 106, or any other platform, via the communication network 108. The communication network 108 may be wired, wireless, or any combination of wired and wireless communication networks, such as cellular, Wi-Fi, internet, local area networks, or the like. In some embodiments, the communication network 108 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

All the components in the network environment 100 may be coupled directly or indirectly to the communication network 108. The components described in the network environment 100 may be further broken down into more than one component and/or combined together in any suitable arrangement. Further, one or more components may be rearranged, changed, added, and/or removed.

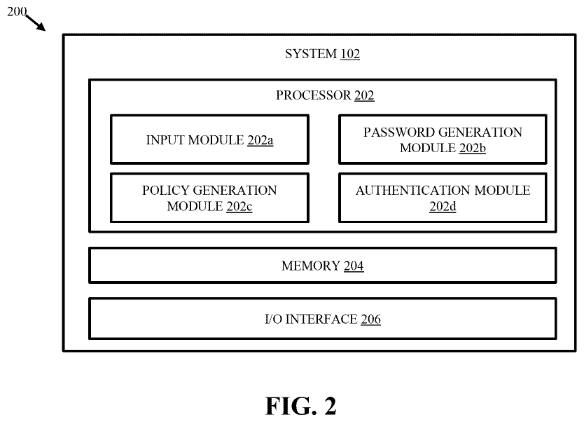

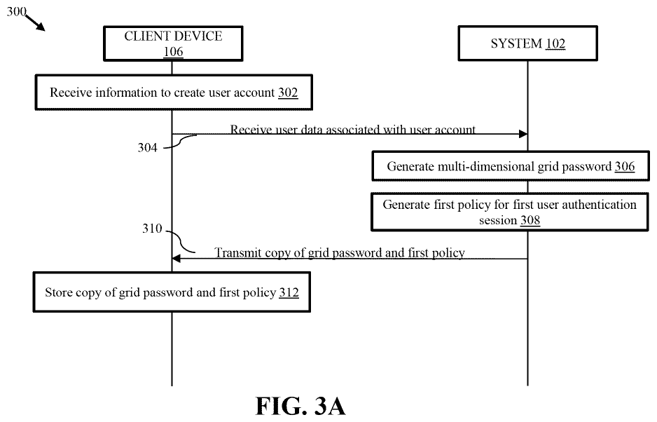

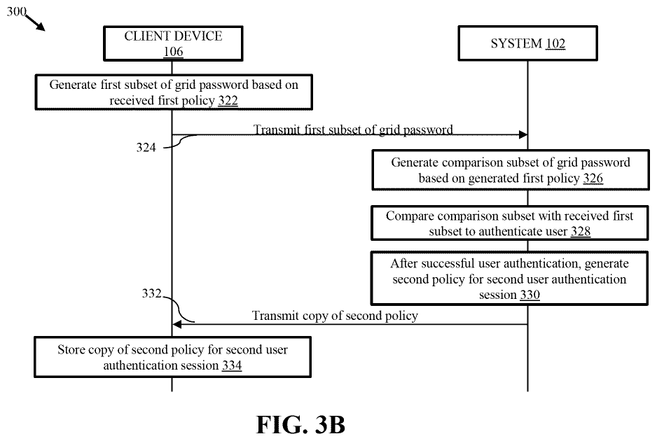

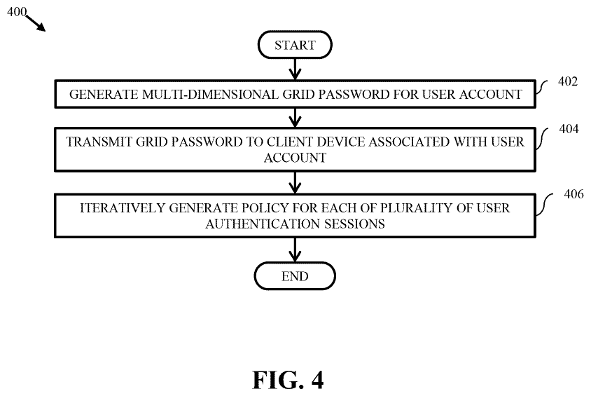

The system 102 may comprise suitable logic, circuitry, and interfaces that may be configured to perform user authentication, enabling access and generating alerts in case of unauthorized access or failed authentication. Details of the operations of the system 102 to perform secure user authentication are described in conjunction with, for example, FIG. 2, FIG. 3A, FIG. 3B and FIG. 4.

FIG. 2 illustrates a block diagram 200 of the system 102 for performing user authentication, in accordance with an example embodiment. FIG. 2 is explained in conjunction with FIG. 1.

The system 102 may include at least one processor 202, a memory 204, and an I/O interface 206. The at least one processor 202 may comprise modules, depicted as an input module 202a, a password generation module 202b, a policy generation module 202c, and an authentication module 202d.

In accordance with an embodiment, the system 102 may store data that may be generated by the modules while performing corresponding operation or may be retrieved from a database associated with the system 102. In an example, the data may include user data, the grid password 110, policy data, and historical user authentication data.

In an example, the input module 202a may be configured to obtain user data for processing. In accordance with an embodiment, the user data may include, for example, user id or user name, contact details, name, location data, email address, gender, etc. In an example, the input module 202a may be configured to obtain the user data provided by the user, such as via the client device 106, to the online platform 104. For example, the user may provide the user data to sign-up on the online platform 104 to create a user account and/or access the services provided by the online platform 104.

Based on the user data obtained by the input module 202a, the password generation module 202b may be configured to generate the grid password 110 for the user account. The grid password 110 may be a multi-dimensional password, such as a multi-dimensional matrix. The grid password 110 may include a set of cells. In an example, every cell in the set of cells in the grid password 110 may have corresponding one or more identifiers. For example, a cell of the grid password 110 may be represented as [x, y, t], where x represents row id of the cell, y represents column id of the cell and t represents time id associated with the cell of the grid password 110. The set of cells may include values that form the grid password 110. The values of the set of cells in the grid password 110 may be an alphabet, a number, a symbol, or a special character. Further, the cells in the grid password 110 may have other corresponding identifiers, such as cell id, row sequence number, column sequence number, value id, and so forth. For example, a number of rows and a number of columns (i.e., size) of the grid password 110 may be, but is not limited to, 4×2, 4×4, 7×3, 10×10, and so forth. To this end, such grid password 110 eliminates single line passwords that are easy to guess and prone to password attacks, such as brute force attack, credential guessing, etc. In an example, the grid password 110 may be stored within the memory 204 of the system 102.

In an example, the grid password 110 or the cells of the grid password 110 may be recognized by the system 102 using a grid description language. The grid description language may indicate the values of the set of cells based on the corresponding one or more identifiers. For example, the grid description language may be a relational database between the values of the cells and the one or more identifiers of the cells.

Once the grid password 110 is generated for the user account of the user, a copy of the grid password 110 may be transmitted to the user, such as to the client device 106. In an example, the copy of the grid password 110 is transmitted to the client device 106 in a number of data packets. For example, each data packet may correspond to a single cell, a sequence of cells, or a selection of random cells. Moreover, the data packets may be encrypted to ensure secure transmission of the grid password 110 to the client device 106. For example, the client device 106 may store the received grid password 110 in a file local to the client device 106 and/or a file that is associated with the email address of the user.

Thereafter, the policy generation module 202c may be configured to generate a policy for authentication of the user. The policy may be a one-time derived function or rule. For example, the policy for a particular session may indicate one or more cells that are to be used for one-time authentication during the session. The policy may indicate a subset of one or more cells from the set of cells in terms of any one of the one or more identifiers of the subset of one or more cells. The policy generation module 202c may iteratively generate policies for different sessions of authentication of the user. To this end, the policy for a session may comprise a unique set of identifiers from the one or more identifiers of each of the set of cells, wherein the unique set of identifiers may correspond to the subset of one or more cells.

In an example, the grid password 110 may be a 2×2 matrix having 4 cells. For example, a first cell may have a row id of ‘11’, column id of ‘21’, cell id of ‘1’, value id of ‘F’, time id of ‘00’, row sequence number of ‘31’ and column sequence number of ‘41’. Similarly, a second cell may have a row id of ‘12’, column id of ‘22’, cell id of ‘2’, value id of ‘Z’, time id of ‘02’, row sequence number of ‘32’ and column sequence number of ‘42’; a third cell may have a row id of ‘13’, column id of ‘23’, cell id of ‘3’, value id of ‘X’, time id of ‘04’, row sequence number of ‘33’ and column sequence number of ‘43’, and a fourth cell may have a row id of ‘14’, column id of ‘24’, cell id of ‘4’, value id of ‘#’, time id of ‘06’, row sequence number of ‘34’ and column sequence number of ‘44’. To this end, each cell may be identified using several identifiers, such as column id, row id, value id, time id, row sequence number and column sequence number. The policy generation module 202c may be configured to use a unique or random combination of these identifiers to identify a subset of cells that are used for generating a policy. For example, for a first user authentication session, the policy generation module 202c may generate a first policy. In an example, the first policy may indicate a function for the first user authentication session using the third cell and the fourth cell. In this regard, the policy may specify the third cell in terms of cell id and time id as [3-04] and the fourth cell in terms of value id and row sequence number as [#-34], together as [3-04; #-34]. In another example, the first policy may indicate a function using sub-functions corresponding to, for example, odd row id, odd column id, even row id, last row id, diagonal row id, even column id, last column id, or a combination thereof. In this manner, the first policy may comprise a plurality of derived sub-functions, such as a chain of sub-functions that together form a one-time function for user authentication. It may be noted that such sub-functions are only exemplary and should not be construed as a limitation.

The first policy may be provided to the client device 106, for example, during the transmittance of the copy of the grid password 110, or during a previous user authentication session. The first policy may also be stored by the system 102 or the processor 202 within the memory 204. Further, based on the first policy, the client device 106 may generate a subset of the multi-dimensional grid password 110 for user authentication during the first user authentication session. For example, the subset of the grid password 110 generated based on the first policy may include a value of the third cell and the fourth cell of the grid password 110. Such subset of the grid password 110 may be transmitted to the system 102 by the client device 106 for authentication of the user during the first user authentication session.

Based on receiving the subset of the grid password 110, the authentication module 202d may be configured to authenticate the user. For example, the authentication module 202d may be configured to retrieve the stored grid password 110 for the user account and the first policy generated for the first user authentication session for the user account. Based on the first policy, the authentication module 202d may determine a comparison subset of the grid password 110 say actual value of the third cell and the fourth cell of the grid password 110. The authentication module 202d may authenticate the user based on comparison between the comparison subset and the received subset of the grid password 110 from the client device 106.

On successful authentication of the user, i.e., when the comparison subset matches the received subset, the user is allowed to access the services of the online platform 104. However, after unsuccessful authentication of the user, i.e., when the comparison subset does not match with the received subset, the user is not allowed to access the services of the online platform 104. In such a case another policy may be generated and transmitted to the client device 106 for another user authentication session.

For example, after the authentication of the user during the first user authentication session, the policy generation module 202c may generate another policy for user authentication during a next session after the first user authentication session. A copy of the another generated policy may be transmitted to the client device 106 during the first user authentication session or after the user authentication in the first user authentication session. Subsequently, in the next session, the second policy may be used to generate another subset of the grid password 110 to be used for user authentication.

It may be noted that the size of the multi-dimensional grid password 110 to be 2×2 with 4 cells is only exemplary and should not be construed as a limitation. In other embodiments, a multi-dimensional grid password may have a large size, say 10×10 or 10×15, etc. In such a case, a large number of cells may be present within the grid password. Moreover, the different identifiers allocated to the cells of the multi-dimensional grid password are arbitrary. To this end, given the complex multi-dimensional grid password, the various identifiers of the cells of the grid password and different policies for different authentication sessions, password attacks due to guessing, password reconstruction, brute force, URL sniffing, etc. can be eliminated or reduced substantially. As a subset of the grid password transmitted over the network for authentication keeps changing during different session, therefore, password guessing password attacks become difficult.

Therefore, use of multi-dimensional grid passwords substantially reduces security threats associated with password attacks.

FIG. 3A shows a sequence diagram 300 that depicts a method for setting up a user account for a user with the multi-dimensional grid password 110, in accordance with an example embodiment. FIG. 3A is explained in conjunction with FIG. 1 and FIG. 2. The sequence diagram 300 may include the client device 106 and the system 102. The sequence diagram 300 may depict operations performed by at least one of the client device 106 and the system 102.

At 302, the client device 106 is configured to receive information to create a user account. In an example, the client device 106 may provide user data to create the user account on the online platform 104. The user data may include, for example, name, email id, contact information, location data, type of user account, and other information relating to the user and/or the user account to be created. The client device 106 may receive the information from the user or a database associated with the user.

At 304, the system 102 is configured to receive the user data from the client device 106. In an example, the system 102 may receive the user data from the client device 106 via the online platform 104.

At 306, the system 102 is configured to generate the grid password 110 for the user account. The grid password 110 is a multi-dimensional password having a set of cells. A cell of the grid password 110 may have a corresponding value and one or more identifiers. The one or more identifiers may be used to identify the cell independently or in a combination thereof. The system 102 may store the grid password 110 within a memory or a database such that the grid password 110 is associated with the user account of the user.

Once the grid password 110 is created, at 308, the system 102 is configured to generate a first policy for a first user authentication session. The first policy is generated before the initiation of the first user authentication session. The first policy is a one-time function that includes a random set of identifiers from the one or more identifiers of the set of cells. The random set of identifiers indicates certain random cells to be used for the first user authentication session. The system 102 stores the first policy in the memory or database associated with the system 102 in conjunction with the user account.

At 310, the system 102 is configured to transmit a copy of the grid password 110 and a copy of the first policy to the client device 106.

At 312, the client device 106 is configured to store the copy of the grid password 110 and the copy of the first policy for upcoming first user authentication session. For example, the copy of the grid password 110 and the copy of the first policy may be stored within, for example, within a local memory of the client device 106 or within a database associated with the email id of the user. Thereafter, the client device 106 uses the stored copy of the grid password 110 for user authentication.

In an example, the system 102 generates the first policy for the first user authentication session before the initiation of the first user authentication session. Further, the first policy is transmitted to the client device 106 during a previous user authentication session or along with the grid password 110. In other words, a policy for an upcoming subsequent user authentication session is generated and transmitted to the client device 106 before the subsequent user authentication session, such as after a previous user authentication session is successfully completed or when the grid password 110 is sent to the client device 106. For example, the client device 106 may generate a first subset of the multi-dimensional grid password 110 based on the first policy for user authentication during the first user authentication session. Details of a user authentication session is described in conjunction with FIG. 3B.

FIG. 3B shows a sequence diagram 320 depicting a method for performing a user authentication session, in accordance with an example embodiment. FIG. 3B is explained in conjunction with FIG. 1, FIG. 2 and FIG. 3A. The sequence diagram 320 may include the client device 106 and the system 102. The sequence diagram 320 may depict operations performed by at least one of the client device 106 and the system 102.

At 322, the client device 106 is configured to generate the first subset of the grid password 110 based on the received first policy. For example, based on the first policy stored by the client device at 106, the client device 106 may identify cells indicated in the first policy. Based on the identified cells, value of such cells may be retrieved from the stored copy of the grid password 110 to generate the first subset of the grid password 110 for the first user authentication session.

At 324, the client device 106 is configured to transmit the first subset of the grid password 110. For example, to initiate the first user authentication session, the client device 106 may transmit the first subset of the grid password 110.

At 326, the system 102 is configured to generate a comparison subset of the grid password 110 based on the first policy. The comparison subset may be generated based on the stored first policy and the stored grid password 110 associated with the user account. For example, the system 102 may identify the cells indicated in the first policy and generate the comparison subset from the grid password 110. The comparison subset may include values of the cells indicated in the first policy.

At 328, the system 102 is configured to compare the comparison subset with the received first subset to authenticate the user. In an example, for the first user authentication session, the first subset received from the client device 106 may be compared with the comparison subset generated based on the first policy. Based on the comparison, the system 102 is configured to authenticate the user.

At 330, after successful authentication of the user during the first user authentication session, the system 102 is configured to generate another policy, say a second policy, for a next user authentication session, say a second user authentication session. After the generation of the second policy, the copy of the first policy may be removed, deleted or archived.

At 332, the system 102 is configured to transmit the generated second policy to the client device 106.

At 334, the client device 106 is configured to store a copy of the second policy for use during the second user authentication session.

FIG. 4 shows a flowchart for implementation of an exemplary method 400 for performing user authentication, in accordance with an example. FIG. 4 is explained in conjunction with FIG. 1, FIG. 2, FIG. 3A and FIG. 3B.

At 402, the multi-dimensional grid password 110 is generated for a user account. The multi-dimensional grid password 110 comprises a set of cells having corresponding one or more identifiers. Examples of the one or more identifiers associated with the cell may include, but is not limited to, cell id, row id, column id, value id, time id, row sequence number, and column sequence number.

At 404, the multi-dimensional grid password 110 is transmitted to the client device 106 associated with the user account. The multi-dimensional grid password 110 may also be stored within a memory associated with the system 102.

At 406, a policy is generated iteratively for each of a plurality of user authentication sessions. For example, for the first user authentication session, the first policy is generated and transmitted to the client device 106 after a previous authentication session, where the current authentication session occurs before the first user authentication session. The policy for a user authentication session, say the first policy for the first user authentication session comprises a random set of identifiers from the one or more identifiers of the set of cells. The random set of identifiers corresponds to a subset of cells, say a first subset of cells of the grid password 110.

Subsequently, during the first user authentication session, the client device 106 generates a subset, say the first subset of the multi-dimensional grid password 110 for user authentication during the first user authentication session. The first subset of the grid password 110 may include a first set of values associated with one or more cells, such as the first subset of cells indicated in the first policy. Based on the first subset of the grid password 110, the user account may be authenticated.

For example, the first subset of the multi-dimensional grid password 110 is encrypted using the first policy. As the first policy is known only to the client device 106 and the system 102, the first subset of the grid password 110 may be considered to be encrypted using the first policy.

In an example, the first policy may be stored by the client device. Further, to initiate the first user authentication session, the client device may generate the first subset of the grid password 110 and transfer the first subset to the system 102 for authentication of the user. In this manner, transfer of complete password is not required for user authentication. Due to high complexity of the grid password 110, arbitrary nature of the generated policies and random values of identifiers of the set of cells, the password attacks can be substantially reduced.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A system for user authentication, comprising
a processor;
a memory coupled to the processor, the memory having stored therein instructions executable by the processor to configure the system to:
generate a multi-dimensional grid password for a user account, the multi-dimensional grid password comprising a set of cells having corresponding one or more identifiers;
transmit the multi-dimensional grid password to a client device associated with the user account; and
iteratively generate a policy for each of a plurality of user authentication sessions, wherein
the policy for each of the plurality of user authentication sessions comprises a random set of identifiers from the one or more identifiers of each of the set of cells, and
a policy for a user authentication session from the plurality of user authentication sessions causes to generate a subset of the multi-dimensional grid password for user authentication during the user authentication session.

2. The system of claim 1, wherein the processor is further configured to:
generate a first policy for a first user authentication session during a previous user authentication session;
store the first policy; and
transmit a copy of the first policy to the client device during the previous user authentication session, wherein the previous user authentication session occurs prior to the first user authentication session.

3. The system of claim 2, wherein the processor is further configured to:
cause the client device to generate a first subset of the multi-dimensional grid password based on the first policy, for user authentication during the first user authentication session.

4. The system of claim 3, wherein the processor is further configured to:
receive the first subset of the multi-dimensional grid password from the client device;
determine a comparison subset, using the stored first policy and the multi-dimensional grid password;
compare the received first subset with the comparison subset; and
authenticate the user for the first user authentication session based on the comparison.

5. The system of claim 3, wherein the first subset of the multi-dimensional grid password is encrypted using the first policy, and wherein the first policy is known to the client and the system.

6. The system of claim 3, wherein the first subset of the multi-dimensional grid password comprises a first set of values corresponding to one or more cells from the set of cells.

7. The system of claim 1, wherein the processor is further configured to:
generate a set of data packets corresponding to the multi-dimensional grid password, wherein each data packet of the set of data packets corresponds to a cell from the set of cells of the multi-dimensional grid password; and
transmit each data packet of the set of data packets consecutively to the client device.

8. A method for user authentication, comprising:
generating a multi-dimensional grid password for a user account, the multi-dimensional grid password comprising a set of cells having corresponding one or more identifiers;
transmitting the multi-dimensional grid password to a client device associated with the user account; and
iteratively generating a policy for each of a plurality of user authentication sessions, wherein
the policy for each of the plurality of user authentication sessions comprises a random set of identifiers from the one or more identifiers of each of the set of cells, and
a policy for a user authentication session from the plurality of user authentication sessions causes to generate a subset of the multi-dimensional grid password for user authentication during the user authentication session.

9. The method of claim 8, further comprising:
generating a first policy for a first user authentication session during a previous user authentication session;
storing the first policy; and
transmitting a copy of the first policy to the client device during the previous user authentication session, wherein the previous user authentication session occurs prior to the first user authentication session.

10. The method of claim 9, further comprising:
causing the client device to generate a first subset of the multi-dimensional grid password based on the first policy, for user authentication during the first user authentication session.

11. The method of claim 10, further comprising:
receiving the first subset of the multi-dimensional grid password from the client device;
determining a comparison subset, using the stored first policy and the multi-dimensional grid password;
comparing the received first subset with the comparison subset; and
authenticating the user for the first user authentication session based on the comparison.

12. The method of claim 10, wherein the first subset of the multi-dimensional grid password is encrypted using the first policy, and wherein the first policy is known to the client and the system.

13. The method of claim 10, wherein the first subset of the multi-dimensional grid password comprises a first set of values corresponding to one or more cells from the set of cells.

14. The method of claim 8, further comprising:
generating a set of data packets corresponding to the multi-dimensional grid password, wherein each data packet of the set of data packets corresponds to a cell from the set of cells of the multi-dimensional grid password; and
transmitting each data packet of the set of data packets consecutively to the client device.

15. A non-transitory computer-readable medium having stored thereon computer-executable instructions, which when executed by one or more processors, cause the one or more processors to execute operations comprising;
generating a multi-dimensional grid password for a user account, the multi-dimensional grid password comprising a set of cells having corresponding one or more identifiers;
transmitting the multi-dimensional grid password to a client device associated with the user account; and
iteratively generating a policy for each of a plurality of user authentication sessions, wherein
the policy for each of the plurality of user authentication sessions comprises a random set of identifiers from the one or more identifiers of each of the set of cells, and
a policy for a user authentication session from the plurality of user authentication sessions causes to generate a subset of the multi-dimensional grid password for user authentication during the user authentication session.

16. The non-transitory computer-readable medium of claim 15, wherein the operations further comprise:
generating a first policy for a first user authentication session during a previous user authentication session;
storing the first policy; and
transmitting a copy of the first policy to the client device during the previous user authentication session, wherein the previous user authentication session occurs prior to the first user authentication session.

17. The non-transitory computer-readable medium of claim 16, wherein the operations further comprise:
causing the client device to generate a first subset of the multi-dimensional grid password based on the first policy, for user authentication during the first user authentication session.

18. The non-transitory computer-readable medium of claim 17, the operations further comprise:
receiving the first subset of the multi-dimensional grid password from the client device;
determining a comparison subset, using the stored first policy and the multi-dimensional grid password;
comparing the received first subset with the comparison subset; and
authenticating the user for the first user authentication session based on the comparison.

19. The non-transitory computer-readable medium of claim 17, wherein the first subset of the multi-dimensional grid password is encrypted using the first policy, and wherein the first policy is known to the client and the system.

20. The non-transitory computer-readable medium of claim 17, wherein the first subset of the multi-dimensional grid password comprises a first set of values corresponding to one or more cells from the set of cells.
